(19) United States
(12) Patent Application Publication
(10) Pub. No.: US 2025/0196767 A1
(43) Pub. Date: Jun. 19, 2025

(54) BATTERY ELECTRIC VEHICLE

(71) Applicant: TOYOTA JIDOSHA KABUSHIKI KAISHA, Toyota-shi (JP)

(72) Inventors: Takahiro UCHIDA, Kasugai-shi (JP); Seiji ARAKAWA, Nisshin-shi (JP); Kazuhito SAKAI, Mishima-shi (JP); Chie FUKUHARA, Toyota-shi (JP)

(73) Assignee: TOYOTA JIDOSHA KABUSHIKI KAISHA, Toyota-shi (JP)

(21) Appl. No.: 18/786,950

(22) Filed: Jul. 29, 2024

(30) Foreign Application Priority Data
Dec. 19, 2023 (JP) 2023-214002

(51) Int. Cl. B60Q 5/00; H04R 5/02

(52) U.S. Cl. CPC B60Q 5/008; H04R 5/02; H04R 2430/20; H04R 2499/13

(57) ABSTRACT

A battery electric vehicle includes one or more processors configured to generate artificial sounds that change responsive to the operating conditions of battery electric vehicle and to provide artificial sounds from speakers mounted on battery electric vehicle. The one or more processors further recognize a driving condition of the other vehicle traveling around battery electric vehicle, and execute at least one of the following first processing and second processing in response to the recognized driving condition of the other vehicle. The first process is a process of changing the sound source of the artificial sound. The second process is a process of generating a harmonic that harmonizes with the artificial sound, superimposing the harmonic on the artificial sound, and outputting the artificial sound from the speaker.

### CROSS-REFERENCE TO RELATED APPLICATION

This application claims priority to Japanese Patent Application No. 2023-214002 filed on Dec. 19, 2023, incorporated herein by reference in its entirety.

### BACKGROUND

### 1. Technical Field

The present disclosure relates to a battery electric vehicle including an electric motor as a driving source.

### 2. Description of Related Art

Japanese Unexamined Patent Application Publication No. 2011-215437 (JP 2011-215437 A) discloses a sound control device mounted on a battery electric vehicle. The sound control device disclosed in JP 2011-215437 A controls a simulated engine sound so that an engine sound generated at the time of a shift change in an engine vehicle is represented as a real sound.

### SUMMARY

Since the electric motor has low-level driving sound, a driver who drives the battery electric vehicle generally has little chance to feel the operating condition of the battery electric vehicle with the sound. Therefore, an artificial sound that changes in response to the operating condition of the battery electric vehicle, such as a simulated engine sound, is generated. Thus, the driver can enjoy driving the battery electric vehicle with sound. For example, the simulated engine sound can give the driver a sense of realism as if the driver were driving an engine vehicle.

By providing a function that allows the driver to enjoy such an artificial sound more, it is possible to improve the degree of satisfaction of the user. One of the things that drivers enjoy is thought to be a change in the artificial sound associated with the traveling of the battery electric vehicle. As an element related to the traveling of the battery electric vehicle, there is a change in the traveling condition of another vehicle traveling around the battery electric vehicle. An object of the present disclosure is to provide a function that allows a driver to enjoy an artificial sound more focusing on a change in a traveling condition of another vehicle traveling around a battery electric vehicle.

One aspect of the present disclosure relates to a battery electric vehicle including an electric motor serving as a driving source. The battery electric vehicle includes one or more processors configured to generate an artificial sound that changes in response to an operating condition of the battery electric vehicle, and output the artificial sound from a speaker mounted on the battery electric vehicle.

The one or more processors are further configured to recognize a traveling condition of another vehicle traveling around the battery electric vehicle.

The one or more processors are further configured to perform at least either of a first process and a second process in response to the traveling condition of the other vehicle. The first process is a process of changing a sound source of the artificial sound. The second process is a process of generating a harmonic sound harmonized with the artificial sound and outputting the harmonic sound from the speaker by superimposing the harmonic sound on the artificial sound.

According to the present disclosure, the first process and the second process are performed in response to the traveling condition of the other vehicle. Therefore, the change in the traveling condition of the other vehicle can be reflected in the change in the artificial sound output from the speaker. Accordingly, it is possible to provide the function that allows the driver to enjoy the artificial sound more. As a result, the degree of satisfaction of the user of the battery electric vehicle can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a battery electric vehicle and a vehicle management system according to an embodiment;

FIG. 2 is a conceptual diagram illustrating an example of a basic functional configuration of a vehicle management system;

FIG. 3 is a conceptual diagram for explaining an outline of a sound source changing function;

FIG. 4A is a conceptual diagram for explaining an outline of a harmonic output function;

FIG. 4B is a conceptual diagram for explaining an outline of a harmonic output function;

FIG. 4C is a conceptual diagram for explaining an outline of a harmonic output function;

FIG. 5A is a diagram illustrating a functional configuration of a vehicle management system related to a sound source change function;

FIG. 5B is a flowchart illustrating a process flow of a process executed by the vehicle management system;

FIG. 6A is a diagram illustrating a functional configuration of a vehicle management system related to a harmonic outputting function;

FIG. 6B is a diagram illustrating a process flow of a process executed by the vehicle management system; and

FIG. 7 is a diagram illustrating an exemplary configuration of a power control system of battery electric vehicle.

### DETAILED DESCRIPTION OF EMBODIMENTS

Embodiments of the present disclosure will be described with reference to the accompanying drawings.

### 1 Battery Electric Vehicle and Vehicle Management System

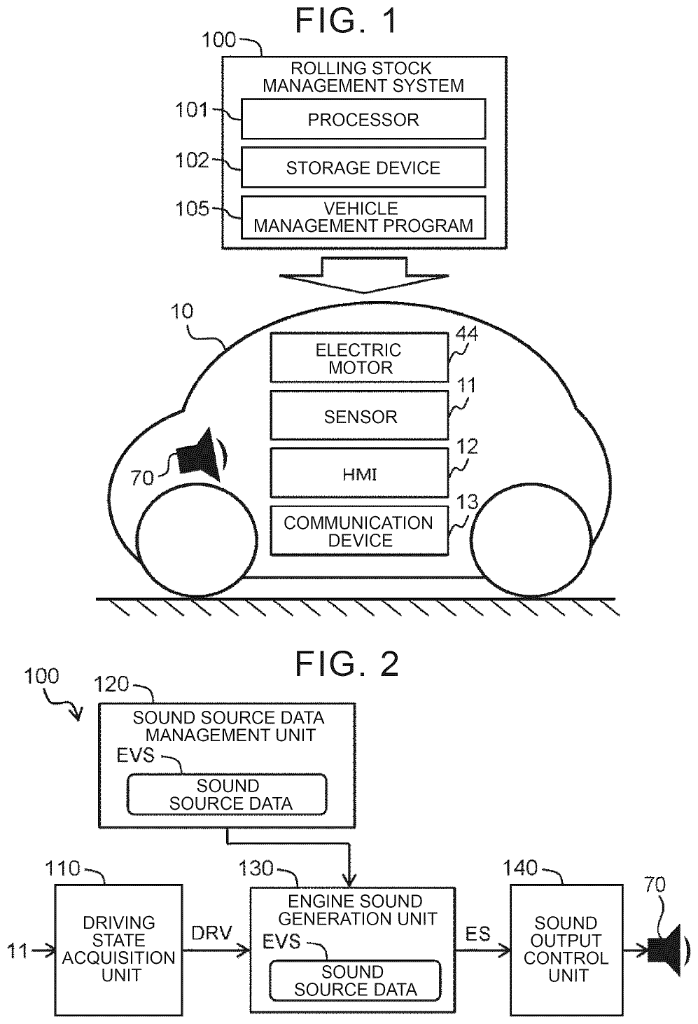

FIG. 1 is a conceptual diagram illustrating a battery electric vehicle 10 and a vehicle management system 100 according to the present embodiment. Battery electric vehicle 10 includes an electric motor 44 as a drive source. Examples of the electric motor 44 include a brushless DC motor and a three-phase AC synchronous motor. Battery electric vehicle 10 uses the electric motor 44 as a driving power device.

Battery electric vehicle 10 includes various sensors 11. The various sensors 11 detect the operating conditions of battery electric vehicle 10. Examples of the various sensors 11 include an accelerator position sensor, a brake position sensor, a steering angle sensor, a steering torque sensor, a wheel speed sensor, an acceleration sensor, a rotation speed sensor, a position sensor, and a recognition sensor. The accelerator position sensor detects an operation amount of the accelerator pedal. The brake position sensor detects an operation amount of the brake pedal. The steering angle sensor detects a steering angle of the steering wheel. The steering torque sensor detects a steering torque of the steering wheel. The wheel speed sensor detects a rotational speed of a wheel of battery electric vehicle 10. The acceleration sensor detects lateral acceleration and longitudinal acceleration of battery electric vehicle 10. The rotational speed sensor detects the rotational speed of the electric motor 44. The position sensor detects the position of battery electric vehicle 10. Examples of the position sensor include a global navigation satellite system (GNSS) sensor. The recognition sensor is a sensor for recognizing (detecting) a situation around battery electric vehicle 10. Examples of the recognition sensor include a camera, light detection and ranging (LIDAR), and a radar.

Further, battery electric vehicle 10 is equipped with one or a plurality of speakers 70. For example, the speaker 70 is an in-vehicle speaker that outputs sound into a vehicle cabin of battery electric vehicle 10. As another example, the speaker 70 may be an outside speaker that outputs sound to the outside of battery electric vehicle 10. Battery electric vehicle 10 may include both an in-vehicle speaker and an out-vehicle speaker.

Battery electric vehicle 10 also includes a human machine interface (HMI) 12 as an interface with the user. HMI 12 presents various types of information to the user by displaying or sounding, and accepts various types of input from the user. HMI 12 includes a display (e.g., a multi-information display, a meter display), a switch, a speakerphone, a touch panel, and the like. The speaker 70 may be configured as a part of HMI 12.

Battery electric vehicle 10 also includes a communication device 13 that communicates with an external device to transmit and receive data. Examples of the communication device 13 include a device that connects to the Internet and transmits and receives information to and from various servers, a device that communicates with infrastructure facilities and transmits and receives infrastructure information, and a device that transmits and receives information to and from surrounding vehicles and transmits and receives other vehicle information.

The vehicle management system 100 is applied to such a battery electric vehicle 10 and manages battery electric vehicle 10. The entire vehicle management system 100 may be mounted on a battery electric vehicle 10. As another example, at least a portion of the vehicle management system 100 may be included in a management server external to battery electric vehicle 10. The vehicle management system 100 may then remotely manage battery electric vehicle 10. As another example, the vehicle management system 100 may be distributed between battery electric vehicle 10 and the management server.

Generally speaking, the vehicle management system 100 includes one or more processors 101 (hereinafter simply referred to as processors 101) and one or more storage devices 102 (hereinafter simply referred to as storage devices 102). The processor 101 executes various processes. The processor 101 includes a general-purpose processor, an application-specific processor, a central processing unit (CPU), a graphics processing unit (GPU), an application specific integrated circuit (ASIC), a field-programmable gate array (FPGA), an integrated circuit, a conventional circuit, and the like. The processor 101 may also be referred to as circuitry or processing circuitry. Circuitry is hardware programmed to implement the described functions, or hardware that performs the functions. The storage device 102 stores various types of information. Examples of the storage device 102 include volatile memory, non-volatile memory, a hard disk drive (HDD), a solid state drive (SSD), and the like. The functions of the vehicle management system 100 are realized by the cooperation of the processor 101 and the storage device 102.

One or more vehicle management programs 105 (hereinafter simply referred to as vehicle management programs 105) are computer programs executed by the processor 101. The functions of the vehicle management system 100 may be realized by cooperation of the processor 101 executing the vehicle management program 105 and the storage device 102. The vehicle management program 105 is stored in the storage device 102. Alternatively, the vehicle management program 105 may be recorded in a computer-readable recording medium.

For example, the vehicle management system 100 has a function as a sound management system that manages sounds related to battery electric vehicle 10. As a function of the sound management system, the vehicle management system 100 generates and manages sound outputted from the speaker 70 mounted on battery electric vehicle 10. In particular, as a function of the sound management system, the vehicle management system 100 generates artificial sounds that change in response to the operating conditions of battery electric vehicle 10. Then, the vehicle management system 100 outputs the generated artificial sound from the speaker 70 mounted on battery electric vehicle 10. The operating state of battery electric vehicle 10 is an operating state of a driving operation member (e.g., an accelerator pedal, a brake pedal, and a steering wheel) by a driver, a running state of a battery electric vehicle 10, and the like. Examples of the artificial sound that changes in response to the operating state include a “simulated engine sound” simulating an engine sound of an engine vehicle. The engine vehicle is a vehicle equipped with an engine (internal combustion engine) and having the engine as a drive source.

Note that the artificial sound generated and output from the speaker 70 is not limited to a pseudo engine sound. For example, the artificial sound may be a simulated driving sound simulating a driving sound of a moving body (for example, a train, an airplane, or the like) different from the automobile. As another example, the artificial sound may be music. In the following description, as an example, the artificial sound is assumed to be a “pseudo engine sound”. However, the technical features of the present disclosure described below are equally applicable to other artificial sounds. In the case of generalization, the “pseudo engine sound” in the following description is appropriately read as “artificial sound”.

FIG. 2 is a block diagram illustrating a basic functional configuration of a vehicle management system 100 as a sound management system. The vehicle management system 100 includes, as functional blocks, a driving state acquisition unit 110, a sound source data management unit 120, an engine sound generation unit 130, and a sound output control unit 140. These functional blocks are realized, for example, by cooperation of the processor 101 executing the vehicle management program 105 and the storage device 102.

The driving state acquisition unit 110 acquires driving state information DRV indicating the operation state of battery electric vehicle 10. Typically, the driving state information DRV includes information detected by sensor 11 mounted on battery electric vehicle 10. For example, the driving state information DRV includes the operating volume of the accelerator pedal (accelerator operation amount), the operating volume of the brake pedal (brake opening), the steering angle, steering speed, steering tightening, wheel speed, wheel speed, vehicle speed, before and after acceleration, horizontal acceleration, the revolving speed of the electric motor 44, and the like. The driving state information DRV may include a position of battery electric vehicle 10.

The driving state information DRV includes a virtual engine rotational speed Ne. Here, it is assumed that battery electric vehicle 10 uses the virtual engine as a driving power device. The virtual engine rotational speed Ne is a rotational speed of the virtual engine when battery electric vehicle 10 is assumed to be driven by the virtual engine. For example, the driving state acquisition unit 110 may calculate the virtual engine rotational speed Ne so as to increase as the wheel speed increases. In addition, when battery electric vehicle 10 includes a manual mode (MT mode) described later, the driving state acquisition unit 110 may calculate the virtual engine rotational speed Ne in the manual mode on the basis of the wheel speed, the overall reduction ratio, and the slip ratio of the virtual clutch. The method of calculating the virtual engine rotational speed Ne will be described later.

The sound source data management unit 120 stores and manages the sound source data EVS used for generating the pseudo-engine sound. The sound source data management unit 120 is mainly implemented by one or a plurality of storage devices 102. Typically, the sound source data EVS includes a plurality of types of sound source data. The plurality of types of sound source data include, for example, sound source data (for low revolutions, medium revolutions, and high revolutions) of sound caused by engine combustion. The plurality of types of sound source data include, for example, sound source data of sound caused by a drive system such as a gear (for a low rotation speed, a medium rotation speed, and a high rotation speed), sound source data of noise sound, sound source data of an event sound (e.g., a gargle sound, an engine sound), and the like. Each sound source data is generated in advance through a simulation based on an engine model and a vehicle model of the engine vehicle, or the like. Each sound source data is flexibly adjustable. That is, at least one of the sound pressure and the frequency of the sound indicated by the sound source data can be flexibly adjusted.

The engine sound generation unit 130 (engine sound simulator) is a simulator that generates a pseudo engine sound. The engine sound generation unit 130 acquires at least a part of the driving state information DRV from the driving state acquisition unit 110. In particular, the engine sound generation unit 130 acquires information on the virtual engine rotational speed Ne and the vehicle speed from the driving state acquisition unit 110. In addition, the engine sound generation unit 130 reads the sound source data EVS from the sound source data management unit 120. Then, the engine sound generation unit 130 combines one or more sound source data included in the sound source data EVS, and the engine sound generation unit 130 combines the sound source data to generate a pseudo engine sound that changes in response to battery electric vehicle 10 operating conditions (virtual engine rotational speed Ne and vehicle speed). The engine sound data ES is data indicating the generated pseudo-engine sound.

Note that the method of generating the pseudo engine sound is not particularly limited in the present embodiment. For example, a well-known method employed in a game or the like may be employed. Further, for example, according to the map of the virtual engine rotational speed Ne-frequency and the map of the virtual engine torque-sound pressure, the frequency may be increased or decreased in proportion to the virtual engine rotational speed Ne, and the sound pressure may be increased or decreased in proportion to the virtual engine torque.

The sound output control unit 140 acquires the engine sound data ES generated by the engine sound generation unit 130. The sound output control unit 140 outputs a pseudo engine sound from the speaker 70 based on the engine sound data ES.

### 2 Simulated Engine Sound in Response to Driving Conditions of Other Vehicles

### 2.1 Overview

As described above, according to the vehicle management system 100, an artificial sound, in particular, a pseudo-engine sound, responsive to the operating condition of battery electric vehicle 10 is outputted from the speaker 70. This allows the drivers to enjoy pseudo-engine sounds while battery electric vehicle 10 is running. In particular, the driver can enjoy a sense of realism such as driving an engine car by listening to a pseudo engine sound.

By providing a function that allows the driver to enjoy such a pseudo engine sound, it is possible to improve the satisfaction of the user. One of the things that the drivers enjoy is thought to be the change in the pseudo-engine sound associated with the running of battery electric vehicle 10. Therefore, the inventors of the present disclosure have focused on other vehicles traveling around battery electric vehicle 10 as an element related to the traveling of battery electric vehicle 10. While battery electric vehicle 10 is traveling, the driving conditions of other vehicles traveling around battery electric vehicle 10 are changing every moment. By reflecting the change in the traveling state of the other vehicle on the change in the pseudo engine sound output from the speaker 70, the driver can be expected to enjoy the pseudo engine sound more.

In view of the above, the vehicle management system 100 according to the present embodiment is configured to provide two functions so that the driver can enjoy the pseudo engine sound more. One is a function of changing a sound source of a pseudo-engine sound in response to a traveling state of another vehicle (hereinafter, also simply referred to as “another vehicle”) surrounding battery electric vehicle 10 (hereinafter, referred to as a “sound source changing function”). The other function is a function of generating a harmonic that harmonizes with the pseudo engine sound and outputting the harmonic sound from the speaker 70 in response to the traveling state of the other vehicle (hereinafter, referred to as a “harmonic sound output function”). Hereinafter, an outline of each function will be described.

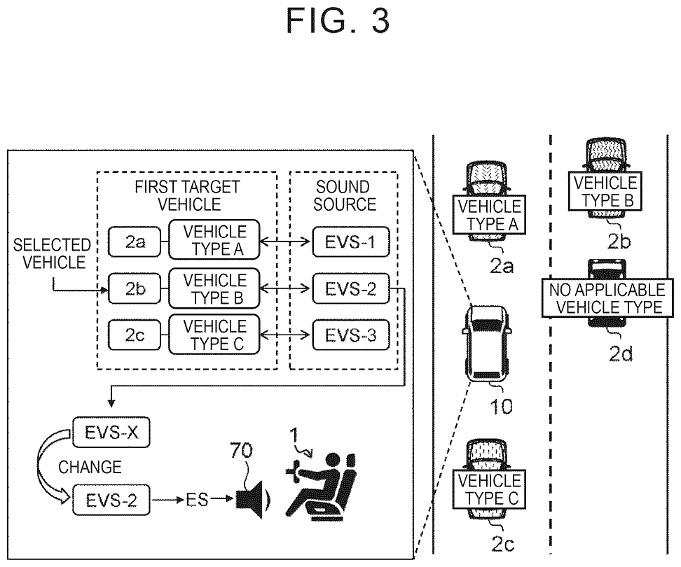

FIG. 3 is a conceptual diagram for explaining an outline of a sound source changing function. First, in the sound source changing function, the traveling state of the other vehicle is recognized. In FIG. 3, four other vehicles 2a, 2b, 2c and 2d are recognized around battery electric vehicle 10.

Next, in the sound source changing function, it is determined whether or not the recognized other vehicle includes the target vehicle (first target vehicle) related to the sound source changing function. The first target vehicle is one of several types of vehicle managed by the vehicle management system 100 (vehicle A, vehicle B, vehicle C, . . . ). In FIG. 3, the other vehicle 2a, 2b and 2c are the first target vehicle, while the other vehicle 2d is not the first target vehicle. In particular, the vehicle management system 100 manages a plurality of sound source data EVS (EVS-1 EVS-2, EVS-3, . . . ) corresponding to each of a plurality of types of vehicles. The first target vehicle may be referred to as a vehicle in which the corresponding sound source data EVS is managed. The sound source data EVS-i (i=1, 2, 3, . . . ) typically indicates a sound source for generating a simulated engine sound simulating an engine sound of a corresponding vehicle type.

When the recognized other vehicle includes the first target vehicle, one of the first target vehicles is selected. The selection may be configured to be performed by the driver 1. For example, the vehicle management system 100 displays a list of the first target vehicles on HMI 12, and receives selection inputs from the driver 1 with respect to the vehicles on the list.

When the selection is performed, the sound source of the pseudo engine sound is changed to a sound source corresponding to the vehicle type of the selected first target vehicle (the selected target vehicle). More specifically, the sound source data EVS used by the engine sound generation unit 130 to generate the pseudo engine sound is changed to the sound source data EVS corresponding to the vehicle type of the vehicle to be selected. As a result, in the sound source changing function, the pseudo engine sound of the sound source corresponding to the vehicle type of the vehicle to be selected is output from the speaker 70. FIG. 3 illustrates a case where the other vehicle 2b is a selection target vehicle. Then, the sound source data EVS used by the engine sound generation unit 130 to generate the pseudo engine sound is changed from the original sound source data EVS-X to the sound source data EVS-2 corresponding to the vehicle type B.

In the sound source changing function, when the recognized other vehicle does not include the first target vehicle, or when the other vehicle is not recognized, the sound source is not changed. When the first target vehicle is not selected from the driver, the sound source may not be changed. In addition, after the sound source is changed, it may be configured so as to be able to return to the original sound source EVS-X according to a request from the driver 1.

As described above, according to the sound source changing function, when the first target vehicle exists around battery electric vehicle 10, the sound source of the pseudo-engine sound can be changed to the sound source corresponding to the vehicle type of the first target vehicle. As a result, the driver 1 can enjoy the pseudo engine sounds of various sound sources in response to the traveling situation of the other vehicle. In particular, by enabling the driver 1 to select the first target vehicle, the driver 1 can enjoy the false-engine sound of the sound source corresponding to the vehicle type when the driver 1 sees a vehicle type that is interesting while battery electric vehicle 10 is traveling. In this way, with the sound source changing function, the driver 1 can enjoy the pseudo engine sound output from the speaker 70.

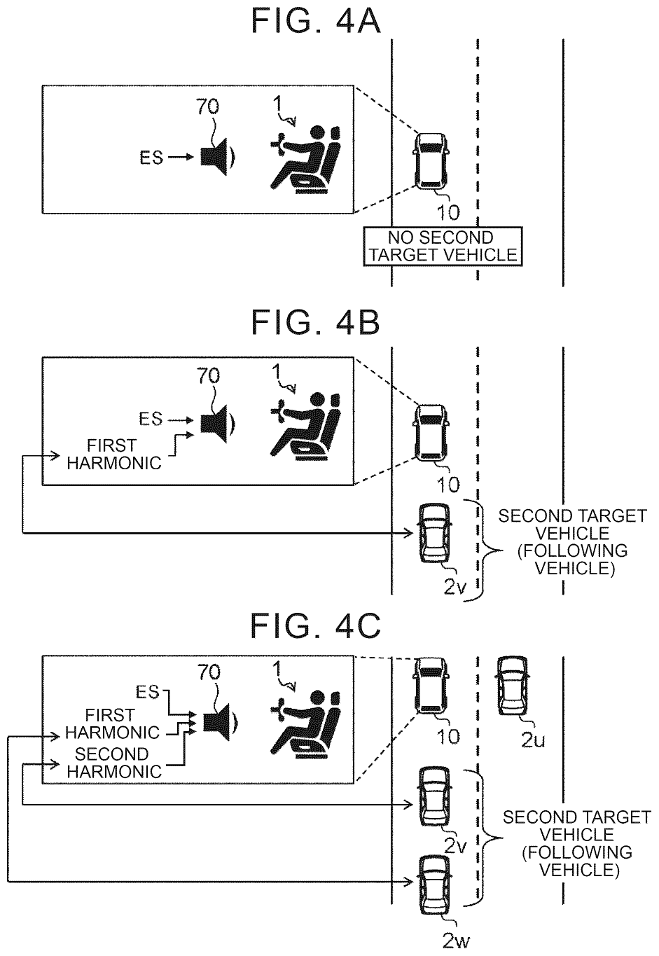

Next, an outline of the harmonic output function will be described. FIGS. 4A to 4C are conceptual diagrams for explaining the outline of the harmonic outputting function. First, in the harmonic output function, as in the sound source change function, recognition of a traveling state of another vehicle is performed. FIG. 4A shows a situation where other vehicles are not recognized. FIG. 4B shows a situation where one other vehicle 2v is recognized. FIG. 4C shows three other vehicles 2u, 2v and when a 2w is recognized.

Next, in the harmonic output function, it is determined whether or not the recognized other vehicle includes the target vehicle (second target vehicle) related to the harmonic output function. The second target vehicle is a vehicle having a particular positional relation with battery electric vehicle 10. An example of a particular positional relationship is located in a range of a certain distance behind battery electric vehicle 10. In other words, the second target vehicle is a subsequent vehicle that is within a certain range from battery electric vehicle 10. The specific positional relationship can be appropriately determined according to the situation to which the present embodiment is applied. For example, a particular positional relation may be located within a certain range in front of battery electric vehicle 10. Hereinafter, the second target vehicle will be described as a subsequent vehicle of battery electric vehicle 10.

In the harmonic output function, when the recognized other vehicle includes the second target vehicle (subsequent vehicle), a harmonic corresponding to each of the second target vehicles is generated. Each harmonic is generated, for example, based on the frequency of the pseudo engine sound output from the speaker 70. For example, each harmonic is generated to be a harmonic of a pseudo-engine sound. Further, the sound source of each harmonic may be changed according to the vehicle type of the corresponding second target vehicle. The generated harmonics are superimposed on the pseudo engine sound and output from the speaker 70.

In the embodiment shown in FIG. 4A, since the other vehicles are not recognized, the harmonics are not generated. Therefore, only the pseudo engine sound is output from the speaker 70. In the embodiment illustrated in FIG. 4B, the other vehicle 2v is the second target vehicle, and the first harmonic corresponding to the other vehicle 2v is generated. A pseudo engine sound and a first harmonic sound are output from the speaker 70. In the embodiment shown in FIG. 4C, the other vehicle 2v and 2w are the second target vehicle, and the first harmonic and the second harmonic corresponding to the other vehicle 2v and 2w are generated. A pseudo engine sound, a first harmonic, and a second harmonic are output from the speaker 70.

In this way, according to the harmonic output function, when the second target vehicle is present around battery electric vehicle 10, the speaker 70 outputs the harmonic corresponding to the second target vehicle in a superimposed manner on the pseudo-engine sound. When the harmonics are superimposed, the driver 1 can feel the pseudo engine sound output from the speaker 70 more heavily. As more harmonics are superimposed, the heavy thickness of the pseudo-engine sounds becomes more pronounced. As a result, the driver 1 can enjoy the change of the pseudo engine sound in response to the traveling situation of the other vehicle. In this way, by the harmonic output function, the driver 1 can enjoy the pseudo engine sound output from the speaker 70.

As described above, the vehicle management system 100 according to the present embodiment is configured to provide a sound source changing function and a harmonic sound output function. Note that the vehicle management system 100 may be configured to provide only one of the sound source change function and the harmonic output function. Hereinafter, the configuration of the vehicle management system 100 related to each function will be described in detail.

### 2.1 Configuration Related to Source Change Function

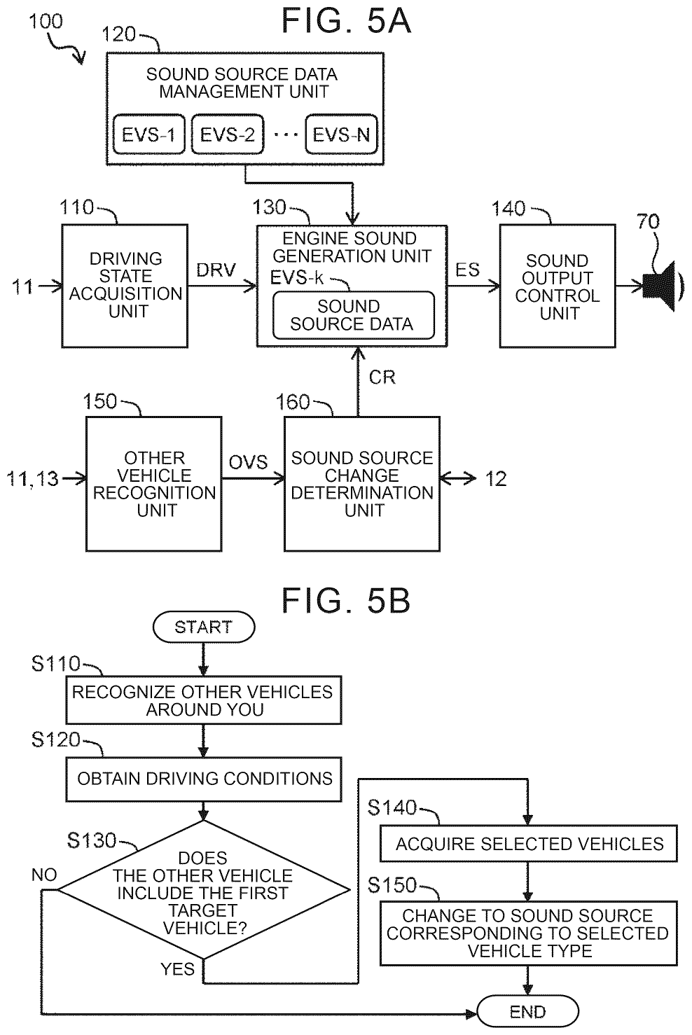

FIG. 5A is a block-diagram illustrating an example of a functional configuration of a vehicle management system 100 related to a sound source change function. In addition to the functional blocks illustrated in FIG. 2, the vehicle management system 100 includes the other vehicle recognition unit 150 and the sound source change determination unit 160 in the example illustrated in FIG. 5A. These functional blocks are realized, for example, by cooperation of the processor 101 executing the vehicle management program 105 and the storage device 102.

The sound source data management unit 120 stores a plurality of sound source data EVS (EVS-1, EVS-2, . . . , EVS-N) corresponding to each of a plurality of types of vehicles as compared with the cases described with reference to FIG. 2. The sound source data EVS-i (1≤i≤N) is generated in advance through a simulation based on an engine model or a vehicle model of a corresponding vehicle type. The engine sound generation unit 130 is configured to read one sound source data EVS among the plurality of sound source data EVS. Initially, the engine sound generation unit 130 may read a particular sound source data EVS (for example, EVS-1) or may read a randomly selected sound source data EVS.

The other vehicle recognition unit 150 recognizes the other vehicle traveling around battery electric vehicle 10, and acquires the recognized traveling status OVS of the other vehicle. For example, the other vehicle recognition unit 150 acquires the traveling status OVS based on the detected information detected by the various sensors 11 and the communication information received by the communication device 13. The traveling status OVS includes information such as the number of other vehicles, the position or relative position of each other vehicle, the type of each other vehicle, the traveling state (vehicle speed, acceleration, attitude, and the like) of each other vehicle, and the like. The other vehicle recognition unit 150 transmits the acquired traveling status OVS to the sound source change determination unit 160.

The sound source change determination unit 160 determines whether to change the sound source of the pseudo engine sound as follows. The sound source change determination unit 160 determines whether or not the other vehicle includes one or a plurality of first target vehicles from the traveling status OVS. When the other vehicle does not include the first target vehicle, the sound source change determination unit 160 determines not to change the sound source. On the other hand, when the other vehicle includes one or more first target vehicles, the sound source change determination unit 160 acquires one selection target vehicle among the one or more first target vehicles. The sound source change determination unit 160 may be configured to receive a selection input from the driver 1 via HMI 12 and set the selected first target vehicle as the selection target vehicle. Upon acquiring the selection target vehicle, the sound source change determination unit 160 determines that the sound source is to be changed, and outputs the change request CR to the engine sound generation unit 130. The change request CR includes information of the sound source data EVS corresponding to the vehicle type of the selected vehicle.

Upon acquiring the change request CR from the sound source change determination unit 160, the engine sound generation unit 130 reads the target sound source data EVS-k from the sound source data management unit 120 in accordance with the change request CR. Then, the engine sound generation unit 130 generates a pseudo engine sound using the read sound source data EVS-k.

By providing the functional configuration of the vehicle management system 100 as described above, it is possible to realize the sound source changing function. FIG. 5B is a flowchart illustrating an example of a processing flow of a processing (first processing) executed by a vehicle management system with respect to a sound source changing function based on the above-described functional configuration. The processing flow illustrated in FIG. 5B may be repeatedly executed at a predetermined processing cycle.

First, the vehicle management system 100 recognizes another vehicle traveling around battery electric vehicle 10 (S110) and acquires the traveling status OVS of the other vehicle (S120).

Next, the vehicle management system 100 determines, based on the obtained traveling status OVS, whether or not the vehicle includes one or a plurality of first target vehicles corresponding to any of a plurality of types of vehicles in which the other vehicle is managed (S130). When the other vehicle does not include the first target vehicle (S130; No), the current process ends without changing the sound source.

When the other vehicle includes one or more first target vehicles (S130; Yes), the vehicle management system 100 acquires one selected vehicle among the one or more first target vehicles (S140). Then, the vehicle management system 100 changes the sound source of the pseudo-engine sound to the sound source corresponding to the vehicle type of the vehicle to be selected (S150). After S150, the present process ends.

### 2.2 Configuration Related to Harmonic Output Function

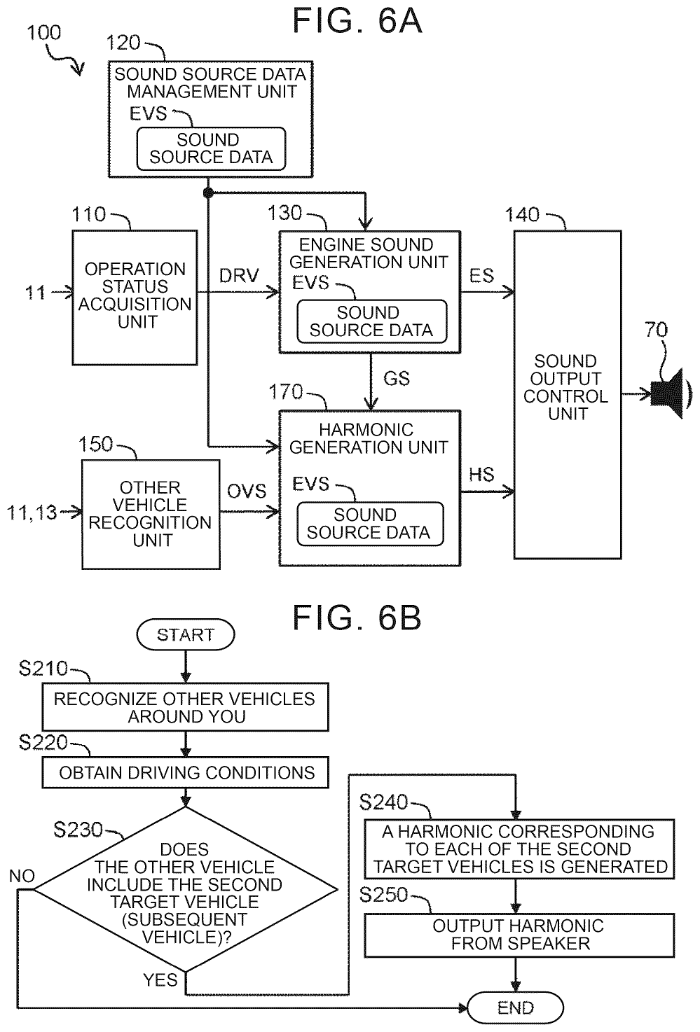

FIG. 6A is a block-diagram illustrating a functional configuration of a vehicle management system 100 related to a harmonic-output function. In addition to the functional blocks illustrated in FIG. 2, the vehicle management system 100 includes an other vehicle recognition unit 150 and a harmonic generation unit 170 in the example illustrated in FIG. 6A. However, the other vehicle recognition unit 150 is the same as that described in FIG. 5A. These functional blocks are realized, for example, by cooperation of the processor 101 executing the vehicle management program 105 and the storage device 102.

The harmonic generation unit 170 acquires the traveling status OVS of the other vehicle from the other vehicle recognition unit 150. In addition, the harmonic generation unit 170 reads the sound source data EVS from the sound source data management unit 120, similarly to the engine sound generation unit 130. Further, the harmonic generation unit 170 acquires the generated pseudo-engine sound generation specification GS from the engine sound generation unit 130. GS includes the sound pressure and frequency of the pseudo-engine sound, the sound source data used, etc.

The harmonic generation unit 170 determines whether or not the other vehicle includes one or a plurality of second target vehicles (subsequent vehicles) from the obtained traveling status OVS. When the other vehicle does not include the second target vehicle, the harmonic generation unit 170 does not generate the harmonic. On the other hand, when the other vehicle includes the second target vehicle, the harmonic generation unit 170 generates one or more harmonic sounds corresponding to each of the one or more second target vehicles from the sound source data EVS and the generation specification GS. The harmonic data HS is data indicating one or a plurality of generated harmonics.

When the harmonic data HS is acquired from the harmonic generation unit 170, the sound output control unit 140 superimposes the harmonic on the pseudo-engine sound based on the harmonic data HS, and outputs the harmonic from the speaker 70.

By providing the functional configuration of the vehicle management system 100 as described above, it is possible to realize the harmonic generation function. FIG. 6B is a flowchart illustrating an example of a processing flow of a processing (second processing) executed by the vehicle management system 100 with respect to the harmonic generation function based on the above-described functional configuration. The processing flow illustrated in FIG. 6B may be repeatedly executed at a predetermined processing cycle.

First, the vehicle management system 100 recognizes another vehicle traveling around battery electric vehicle 10 (S210) and acquires the traveling status OVS of the other vehicle (S220).

Next, the vehicle management system 100 determines whether or not the other vehicle includes one or a plurality of second target vehicles (subsequent vehicles) based on the obtained traveling status OVS (S230). When the other vehicle does not include the second target vehicle (S230; No), the present process ends without outputting a harmonic.

When the other vehicle includes one or a plurality of second target vehicles (S230; Yes), the vehicle management system 100 generates the harmonics corresponding to the respective second target vehicles (S240). Then, the vehicle management system 100 superimposes the generated harmonics on the pseudo-engine sound and outputs the pseudo-engine sound from the speaker 70 (S250). After S250, the present process ends.

3 Applications to Battery Electric Vehicle with Manual Mode (MT Mode)

An electric motor is used as a driving power device in a typical battery electric vehicle. Electric motors differ greatly from internal combustion engines, which have been used as driving power devices in conventional vehicles (CV). Due to differences in the torque-characteristics of the power plant, CV requires a transmission, whereas battery electric vehicle generally does not include a transmission. Of course, a typical battery electric vehicle does not include a manual transmission (MT) that switches the gear ratio by manual operation of a driver. Therefore, there is a large difference in driving sensation between driving of a manual transmission vehicle (hereinafter, referred to as an MT vehicle) and driving of a battery electric vehicle.

On the other hand, the electric motor can relatively easily control the torque by controlling the applied voltage and field. Therefore, in the electric motor, it is possible to obtain a desired torque characteristic within the operating range of the electric motor by performing appropriate control. By taking advantage of this characteristic, the torque of battery electric vehicle can be controlled to simulate the torque characteristic peculiar to MT vehicles. In addition, a simulated shifter that simulates a transmission member used for shifting an MT vehicle may be provided in battery electric vehicle so that the driver can obtain a driving feeling such as an MT vehicle. As a result, MT vehicles can be simulated in battery electric vehicle.

In other words, battery electric vehicle controls the power of the electric motor so as to simulate MT vehicle-specific operating characteristics (torque-characteristics). The driver performs a pseudo manual shift operation by operating a pseudo shifter. Responsive to the simulated manual shifting by the drivers, battery electric vehicle simulates MT vehicles and changes the operating characteristics (torque-characteristics). This allows the drivers of battery electric vehicle to feel as if they are driving MT vehicles. The control mode of the electric motor for simulating the driving characteristic of MT vehicles and the manual shift operation is hereinafter referred to as a “manual mode” or a “MT mode”.

The disclosed battery electric vehicle 10 may comprise such a manual mode (MT mode). In MT mode, battery electric vehicle 10 generates a pseudo engine sound corresponding to the driving operation of the driver, and outputs the pseudo engine sound from the speaker 70. Since not only driving maneuvers of MT vehicles but also engine sounds of MT vehicles are reproduced, the degree of satisfaction of drivers seeking reality is increased.

Hereinafter, an exemplary configuration of a battery electric vehicle 10 including a manual mode (MT mode) will be described.

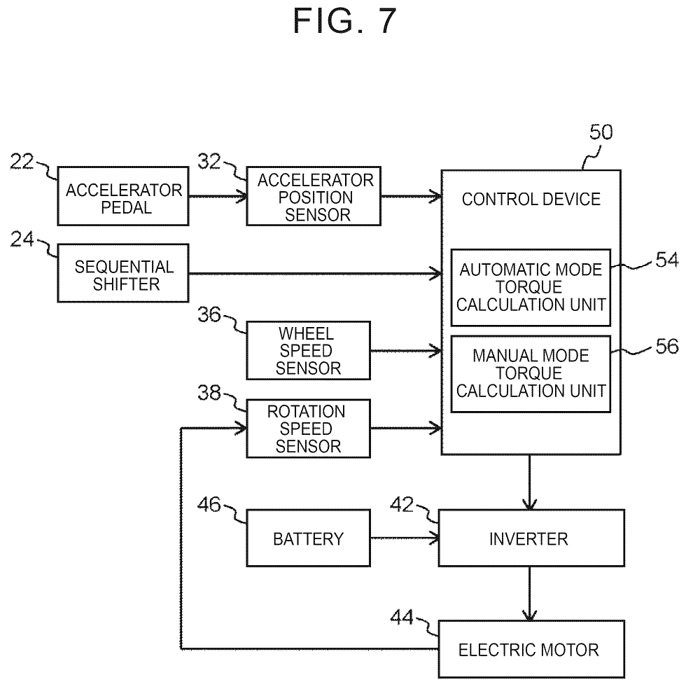

FIG. 7 is a diagram illustrating an exemplary configuration of a power control system of battery electric vehicle 10 according to the present embodiment. The battery 46 stores electrical energy that drives the electric motor 44. That is, battery electric vehicle 10 is a battery electric vehicle (BEV) that runs with the electric energy stored in the battery 46. The inverter 42 converts DC power input from the battery 46 into drive power of the electric motor 44 at the time of acceleration. In addition, the inverter 42 converts the regenerative power input from the electric motor 44 into DC power at the time of deceleration, and charges the battery 46.

Battery electric vehicle 10 comprises an accelerator pedal 22 for the driver to enter an acceleration demand for battery electric vehicle 10. The accelerator pedal 22 is provided with an accelerator position sensor 32 for detecting an accelerator operation amount.

Battery electric vehicle 10 comprises a sequential shifter 24. The sequential shifter 24 is a simulated shifter that simulates a shifter provided in an original MT vehicle. The sequential shifter 24 may be a paddle-type pseudo shifter or a lever-type pseudo shifter.

In the case of a paddle-type pseudo-shifter, the sequential shifter 24 comprises an upshift switch and a downshift switch for determining the operating position. The upshift switch is pulled forward to emit an upshift signal, and the downshift switch is pulled forward to emit a downshift signal.

On the other hand, in the case of a lever-type pseudo shifter, the sequential shifter 24 is configured to output an upshift signal by tilting the shift lever forward, and output a downshift signal by tilting the shift lever backward.

The wheel of battery electric vehicle 10 is provided with a wheel speed sensor 36. The wheel speed sensor 36 is used as a vehicle speed sensor for detecting the vehicle speed of battery electric vehicle 10. Further, the electric motor 44 is provided with a rotation speed sensor 38 for detecting the rotation speed thereof.

Battery electric vehicle 10 includes a control device 50. The control device 50 is typically an electronic control unit (ECU) mounted on a battery electric vehicle 10. The control device 50 may be a combination of a plurality of ECU.

The control device 50 controls the electric motor 44 by PWM control of the inverter 42. The control device 50 calculates a motor torque command for controlling PWM of the inverter 42.

The control device 50 includes an automated mode (EV mode) and a manual mode (MT mode) as control modes. The automatic mode is programmed to continuously change the output of the electric motor 44 in response to operation of the accelerator pedal 22. On the other hand, the manual mode is a control mode for driving battery electric vehicle 10 like MT vehicles. The manual mode is programmed to vary the output characteristics of the electric motor 44 for operation of the accelerator pedal 22 in response to upshift and downshift operations on the sequential shifter 24.

The control device 50 comprises an automatic mode torque calculation unit 54 and a manual mode torque calculation unit 56. The units 54 and 56 may be independent ECU or ECU functions obtained by executing programs stored in memories on a processor.

The automatic mode torque calculation unit 54 has the function of calculating the motor torque when the electric motor 44 is controlled in the automatic mode. The automatic mode torque calculation unit 54 stores a motor torque command map. The motor torque command map is a map for determining the motor torque from the accelerator operation amount and the rotational speed of the electric motor 44. A signal of the accelerator position sensor 32 and a signal of the rotation speed sensor 38 are input to each parameter of the motor torque command map. The motor torque corresponding to these signals is output from the motor torque command map. Therefore, in the automatic mode, even if the driver operates the sequential shifter 24, the operation is not reflected in the motor torque.

The manual mode torque calculation unit 56 comprises a MT vehicle-model. MT vehicle model is a model for calculating the drive wheel torque that would be obtained by operating the accelerator pedal 22 and the sequential shifter 24 assuming that battery electric vehicle 10 is a MT vehicle.

MT vehicle model includes an engine model, a clutch model, and a transmission model. The engine model calculates a virtual engine rotational speed and a virtual engine output torque. The virtual engine rotational speed is calculated from the wheel speed, the overall reduction ratio, and the slip ratio of the virtual clutch. The virtual engine output torque is calculated from the virtual engine rotational speed and the accelerator operation amount. In the calculation of the virtual engine output torque, a map that defines the relationship between the accelerator operation amount, the virtual engine rotational speed, and the virtual engine output torque is used.

The clutch model calculates a torque transmission gain. The torque transmission gain is a gain for calculating the torque transmission degree of the virtual clutch according to the virtual clutch opening degree. In the calculation of the torque transmission gain, a map defining a relationship between the virtual clutch opening degree and the torque transmission gain is used.

The clutch model calculates the clutch output torque by using the torque transmission gain. The clutch output torque is a torque output from the virtual clutch. Further, the clutch model calculates a slip ratio. The slip rate is used to calculate the virtual engine speed in the engine model. The slip ratio can be calculated using a map in which the slip ratio is given to the virtual clutch opening degree in the same manner as the torque transmission gain.

The transmission model calculates the gear ratio (transmission ratio). The gear ratio is a gear ratio determined by the virtual gear stage in the virtual transmission. In the calculation of the gear ratio, a map that defines the relationship between the gear ratio and the virtual gear stage is used. The transmission model calculates the transmission output torque using the gear ratio and the clutch output torque obtained from the map. The transmission output torque varies discontinuously in response to the change of the gear ratio. This discontinuous change in the transmission output torque causes a shift shock, which produces a vehicle design with a stepped transmission.

In MT vehicle model, the drive wheel torque is calculated from the transmission output torque calculated by the transmission model using a predetermined reduction ratio. For example, the drive wheel torque is given by the product of the transmission output torque and the reduction ratio.

The control device 50 converts the drive wheel torque calculated by MT vehicle-model into a required motor torque. The required motor torque is a motor torque required to realize the drive wheel torque calculated by MT vehicle model. The reduction ratio from the output shaft of the electric motor 44 to the drive wheels is used to convert the drive wheel torque to the required motor torque. Then, the control device 50 controls the electric motor 44 via the control of the inverter 42 according to the required motor torque.

In this way, the control device 50 performs torque control of the electric motor 44 in the manual mode. As described above, in the manual mode, the motor torque output by the electric motor 44 changes in response to the operating state of the accelerator pedal 22 and the sequential shifter 24 (pseudo shifter).

In the above-described configuration example, a case has been described in which the pseudo shifter is configured by the sequential shifter 24. As the configuration of the pseudo-shifter, another configuration that is assumed in actual MT vehicles may be adopted. For example, the pseudo shifter may include a pseudo shift lever and a pseudo clutch pedal. For example, the pseudo shift lever is provided with positions corresponding to gear stages of 1 speed, 2 speed, 3 speed, 4 speed, 5 speed, backward, and neutral. The pseudo clutch pedal is operated when the pseudo shift lever is operated. Also in such a configuration, the control device 50 can control the electric motor 44 in each of the automatic mode and the manual mode in the same manner as described above. However, in such a configuration, in the manual mode, the control device 50 determines the virtual gear stage by the shift position of the pseudo shift lever.

What is claimed is:

1. A battery electric vehicle comprising:
an electric motor serving as a driving source; and
one or more processors configured to generate an artificial sound that changes in response to an operating condition of the battery electric vehicle, and output the artificial sound from a speaker mounted on the battery electric vehicle, wherein the one or more processors are further configured to:
recognize a traveling condition of another vehicle traveling around the battery electric vehicle; and
perform, in response to the traveling condition of the other vehicle, at least either of a first process for changing a sound source of the artificial sound and a second process for generating a harmonic sound harmonized with the artificial sound and outputting the harmonic sound from the speaker by superimposing the harmonic sound on the artificial sound.

2. The battery electric vehicle according to claim 1, further comprising one or more storage devices configured to store a plurality of sound sources associated with a plurality of vehicle types, wherein
the one or more processors are configured to perform the first process when the other vehicle includes one or more first target vehicles corresponding to any one of the vehicle types, and
the one or more processors are configured to, in the first process:
acquire one selection target vehicle among the one or more first target vehicles; and
change the sound source of the artificial sound to a sound source associated with a vehicle type of the selection target vehicle among the plurality of sound sources.

3. The battery electric vehicle according to claim 1, wherein:
the one or more processors are configured to perform the second process when the other vehicle includes one or more second target vehicles in a specific positional relationship with the battery electric vehicle; and
the harmonic sound includes one or more harmonic sounds associated with the one or more second target vehicles.

4. The battery electric vehicle according to claim 3, wherein the one or more second target vehicles are succeeding vehicles behind the battery electric vehicle.

5. The battery electric vehicle according to claim 1, wherein the artificial sound is a simulated engine sound simulating an engine sound of an engine vehicle.
